(19) United States
(12) Patent Application Publication
(10) Pub. No.: US 2008/0299402 A1
(43) Pub. Date: Dec. 4, 2008

(54) Polyimide film, polyimide metal laminate and process for producing the same

(75) Inventors: Masao Kawaguchi, Ichihara-shi (JP); Eiji Ohtsubo, Chiba-shi (JP); Takeshi Tsuda, Ichihara-shi (JP); Shuji Tahara, Ichihara-shi (JP); Kenji Iida, Chiba-shi (JP)

Correspondence Address: BUCHANAN, INGERSOLL & ROONEY PC, POST OFFICE BOX 1404, ALEXANDRIA, VA, 22313-1404, US

(73) Assignee: Mitsui Chemicals, Inc., Minato-ku (JP)

(21) Appl. No.: 11/987,650

(22) Filed: Dec. 3, 2007

Related U.S. Application Data
(63) Continuation-in-part of application No. PCT/JP2006/310291, filed on May 24, 2006.

(30) Foreign Application Priority Data
Jun. 3, 2005 (JP) 2005-163466

(51) Int. Cl. B32B 27/06; B32B 37/14

(52) U.S. Cl. 428/473.5; 156/278; 156/331.9

(57) ABSTRACT

The present invention relates to a polyimide-metal laminate that ensures a high adhesion of a metal layer and suitable for use as a material of a high density circuit board. In particular, it provides a polyimide film characterized by having undergone a surface treatment with an alkaline aqueous solution containing a permanganate. The alkaline aqueous solution preferably contains a hydroxide. It also provides a polyimide-metal laminate characterized in that on a surface of the polyimide film a thermoplastic polyimide layer and a metal layer are formed, and a method of producing the polyimide-metal laminate.

### TECHNICAL FIELD

The present invention relates to a polyimide film, a polyimide-metal laminate using the polyimide film and a process for producing the same. More particularly, it relates to the polyimide-metal laminate excellent in adhesion between the polyimide film and a metal layer via an adhesive layer and suitable as a substrate for a high-density circuit board and a process for producing the same.

### BACKGROUND ART

A polyimide-metal laminate is mainly used as a material for circuit board and used as a base material for a printed wiring board, a base material for an integrated suspension, a wiring base material for IC package, a heating sheet, a wiring base material for LCD and the like. In recent years, as electronic devices have been miniaturized and increased in density, use of the polyimide-metal laminate capable of mounting parts and elements in high density is increasing. Further, a line width of the circuit pattern has been further developed to microfabricate to 10 μm to 50 μm in order to achieve high density in a circuit, therefore a polyimide-metal laminate excellent in adhesion of a metal layer and polyimide film has been desired. Generally, a polyimide film and a metal foil (for example, copper foil) are generally adhered with various adhesives in application of such circuit board materials. However, due to the chemical structure and high chemical (solvent) resistance, the polyimide film often results in insufficient adhesion to a copper foil even if mediated with the adhesive. And thus, at present the polyimide film is subjected to various surface treatments (for example, treatment with application of coupling agents, sandblast treatment, corona discharge treatment, plasma treatment, alkali treatment and the like) followed by adhesion to the metal foil with an adhesive.

The polyimide film surface-treated with application of coupling agents is likely to decrease its electrical properties due to silicon residue. Sandblast treatment also leaves a problem in washing process to remove abrasives attached to the polyimide film. On the other hand, corona discharge treatment and plasma treatment are favorable treatments because the equipments for the treatment can be incorporated (inline implementation) into a film forming machine due to their simplicity, and a slight improvement in adhesion is recognized. However, when the polyimide type adhesive is used as an adhesive to glue the metal foil to the polyimide film treated with corona discharge or plasma, an improvement of adhesion has not been recognized at all and such treatment has a problem in practical use.

A technique is also known to improve adhesion to a metal layer by alkali etching of the surface of polyimide film (see Patent Document 1). However, in the Patent Document 1, concerning the adhesion, it is only described that the adhesion is improved only by simple treatment of the polyimide films with an alkaline aqueous solution. Also, there is no examination on the composition of such an alkaline aqueous solution, and there were cases in which adhesion was decreased by the alkali etching.

### Patent Document 1: Japanese Patent Laid Open Publication 2004-533723

### DISCLOSURE OF THE INVENTION

### Problems to be Solved by the Invention

An object of the present invention is to provide a polyimide film to which a metal foil can be adhered with a high adhesion with a polyimide type adhesive and provide a polyimide-metal laminate excellent in adhesion between the metal layer and the polyimide film by placing the metal layer on the layer comprising the polyimide type adhesive formed on the polyimide film.

### Means for Solving the Problems

The inventors earnestly studied to remedy the above problems and found that a polyimide film surface-treated with an alkaline aqueous solution containing a permanganate can strongly adhere to a metal foil with a polyimide type adhesive to complete the present invention.

Further, they found that the above problems can be solved by application of such a polyimide film to a polyimide-metal laminate having a polyimide film, a thermoplastic polyimide-containing layer adjacent to the polyimide film and a metal layer placed on an outside of the thermoplastic polyimide-containing layer. And they completed the invention.

The present invention firstly relates to a polyimide film below:

[1] A polyimide film adhered with a polyimide type adhesive, which is surface-treated with an alkaline aqueous solution containing a permanganate;
[2] The polyimide film according to [1], in which the alkaline aqueous solution above further comprises a hydroxide;
[3] The polyimide films according to [2], in which a weight ratio of the permanganate and the hydroxide contained in the alkaline aqueous solution is 9:1 to 2:8;
[4] The polyimide film according to [2], in which the permanganate is at least either one of potassium permanganate or sodium permanganate and the hydroxide is at least either one of potassium hydroxide or sodium hydroxide; and
[5] The polyimide film according to [1], in which the polyimide film comprises the polyimide which is a polycondensate of an acid dianhydride component and a diamine component, wherein 50 mol % or more of the acid dianhydride component are the acid dianhydride represented by the following general formula (1) and 50 mol % or more of the diamine component are the diamine represented by the following general formula (4).

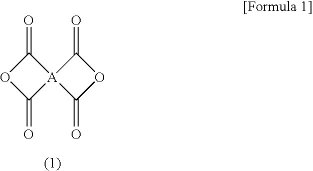

(In the formula (1), “A” indicates the following formula (2) or the following general formula (3)).

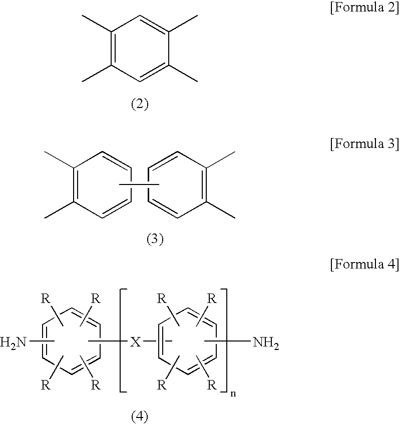

(In the formula (4),
“In” indicates an integer of 0 or 1,
“—X—” indicates —O—, —NHC(═O)— or a direct bond,
“R” indicates a hydrogen atom, a halogen atom, a lower alkyl group or a lower alkoxy group and each “R” may be the same or different).
[6] The polyimide film according to any of [1] to [5] in which the polyimide type adhesive comprises a thermoplastic polyimide or a thermoplastic polyimide precursor and a bismaleimide represented by the following general formula (5).

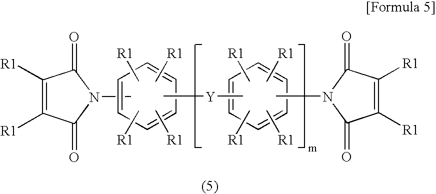

(In the formula (5),
“m” indicates an integer of 0 to 4,
“—Y—” indicates —O—, —SO₂—, —S—, —CO— or a direct bond and each “Y” may be the same or different when there are plural “Y” and
“R1” indicates a hydrogen atom, a halogen atom or a hydrocarbon group and each “R1” may be the same or different and is bonded to a different carbon.)

The polyimide film according to [6], in which the bismaleimide is represented by the following general formula (5′),

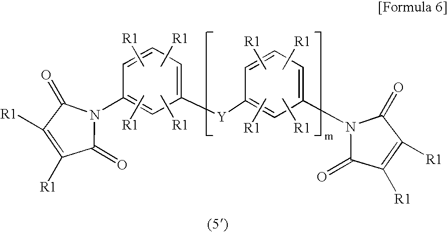

(In the formula (5′),
“m” is an integer of 0 to 4,
“—Y—” indicates —O—, —SO₂—, —S—, —CO— or a direct bond and each “Y” may be the same or different when there are plural “Y” and
“R1” indicates a hydrogen atom, a halogen atom or a hydrocarbon group and each “R1” may be the same or different and is bonded to a different carbon, respectively.)

The present invention secondly relates to a polyimide-metal laminate below and a process for producing the same.

[8] A polyimide-metal laminate comprising the polyimide film according to any of [1] to [7], a thermoplastic polyimide-containing layer placed on both surfaces or one surface of the polyimide film, and a metal layer placed on an outside of the thermoplastic polyimide-containing layer.
[9] A method of producing a polyimide-metal laminate comprising a step for providing the polyimide film according to any of [1] to [7], a step for applying a polyimide type adhesive to one surface or both surfaces of the polyimide film to form a thermoplastic polyimide-containing layer, and a step forming a metal layer on an outside of the thermoplastic polyimide-containing layer.

### EFFECT OF INVENTION

The present invention can provide a polyimide film having good adhesion to a metal foil adhered with a polyimide type adhesive. By using such a polyimide film, a polyimide-metal laminate suitable for a base material for a high-density circuit board can be provided.

### BEST MODES FOR CARRYING OUT THE INVENTION

The polyimide film, the polyimide-metal laminate, and the method for producing the polyimide-metal laminate according to the invention are specifically described below.

### 1. Polyimide Film of Present Invention

The polyimide film of the present invention is characterized in that one surface or both surfaces of it are treated with an alkaline aqueous solution containing permanganate.

A material of the polyimide film of the present invention is not particularly limited. A material of the polyimide film is preferably a film comprising resin composition containing non-thermoplastic polyimide. The non-thermoplastic polyimide contained in the resin composition is polycondensate of a raw material composition containing acid dianhydride component and diamine component. A mole ratio of the acid dianhydride component and the diamine component (acid dianhydride component:diamine component) contained in the raw material composition is preferably 0.95:1.00 to 1.00:0.95, more preferably 1.00:1.00 to 0.985:1.00.

The acid dianhydride component contained in the raw material composition of the non-thermoplastic polyimide preferably includes the acid dianhydride represented by the following general formula (1). More preferably, 50 mol % or more of the acid dianhydride component are the acid dianhydride represented by the general formula (1). In the general formula (1), “A” is the group represented by the following formula (2) or the general formula (3).

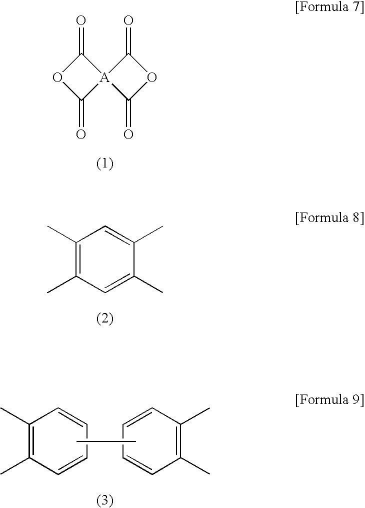

Preferred examples of the acid dianhydride represented by the general formula (1) include pyromellitic dianhydride and biphenyltetracarboxylic dianhydride.

The acid dianhydride component contained in the raw material composition of the non-thermoplastic polyimide may be one kind of the acid dianhydrides, but also a combination of two kinds or more of the acid dianhydrides.

The acid dianhydride component may also contain the acid dianhydride besides the acid dianhydride represented by the general formula (1), the content of which is within a range which the effect of the present invention is not impaired in and preferably below 50 mol % of the acid dianhydride component.

On the other hand, the diamine component contained in the raw material composition of the non-thermoplastic polyimide preferably contains the diamine represented by the following general formula (4). More preferably, 50 mol % or more of the diamine component are the diamine represented by the general formula (4). In the general formula (4), “n” indicates an integer of 0 or 1, —X— indicates —O—, —NHC(C═O) ora direct bond. “R” indicates a hydrogen atom, a halogen atom, a lower alkyl group and a lower alkoxy group and each “R” may be the same or different.

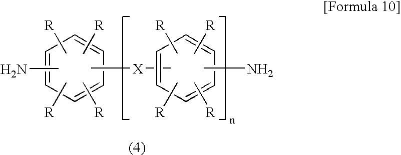

Preferred examples of the diamine represented by the general formula (4) include p-phenylenediamine, m-phenylenediamine, 4,4′-diaminodiphenyl ether, 3,4′-diaminodiphenyl ether, 3,3′-diaminodiphenyl ether, 4,4′-diamino-2,2′-dimethylbiphenyl, 4,4′-diamino-3,3′-dimethylbiphenyl, 2-methoxy-4,4′-diaminobenzanilide, 2′-methoxy-4,4′-diaminobenzanilide and the like.

The diamine component contained in the raw material composition of the non-thermoplastic polyimide may be one kind of the diamines, but also a combination of two kinds or more of the diamines. The diamine component contained in the raw material composition may also include the diamine besides the diamine represented by the general formula (4), the content of which is within a range which the effect of the present invention is not impaired in and preferably below 50 mol % of the acid diamine component.

By using the polyimide film obtained from these raw material components, it is possible to receive more benefits of the effect of the present invention.

A polyimide film of the present invention to be surface-treated may be a commercially available polyimide film, including, for example, UPILEX™S, UPILEX™SGA, UPILEX™SN (produced by Ube Industries, Ltd. trade name), Kapton™H, Kapton™V, Kapton™EN (produced by Toray-Dupont, Ltd., trade name), Apical™AH, Apical™NPI, Apical™NPP, Apical™HP (produced by Kaneka Corp., trade name) and the like.

A thickness of the polyimide film of the present invention is not particularly limited, it may be appropriately adjusted according to application of the polyimide-metal laminate produced from the polyimide film. A thickness of the polyimide film is preferably to 250 μm.

As described above, while the polyimide film of the present invention is characterized in its surface treatment with an alkaline aqueous solution containing permanganate. One surface or both surfaces of the polyimide film can be subjected to the surface treatment.

The alkaline aqueous solution used for the surface treatment of the polyimide films has to contain permanganate and be alkaline. The pH of the alkaline aqueous solution is preferably 9 or higher. Preferred examples of the permanganate contained in the alkaline aqueous solution include potassium permanganate, sodium permanganate and the like and these may be used solely or in combination of two kinds or more.

Further, the alkaline aqueous solution preferably contains permanganate and hydroxide. Preferred examples of the hydroxide include potassium hydroxide, sodium hydroxide and the like and these may be used solely or in combination of two kinds or more.

A weight ratio of the permanganate and the hydroxide contained in the alkaline aqueous solution is preferably in a range of 9:1 to 2:8, more preferably in a range of 8:2 to 3:6, further more preferably in a range of 7:3 to 6:4.

The sum weight of the permanganate and the hydroxide in the alkaline aqueous solution used for the surface treatment of the polyimide film is preferably 3% or more of total weight of the aqueous solution, more preferably in a range of 4% to 30%, more preferably in a range of 5% to 20%, further more preferably 6% to 15%. The alkaline aqueous solution may further contain any other components.

A means to treat surface of the polyimide film with the alkaline aqueous solution is not particularly limited. It includes, for example, a method to immerse the polyimide film in the alkaline aqueous solution in a batch type bath and a method to atomize or spray the alkaline aqueous solution by a sprayer or shower onto the polyimide film. A conveyable roll-to-roll method may also be used to treat surface continuously.

Because the permanganate has risk for combustion or explosion due to oxidizing properties, temperature of the alkaline aqueous solution is preferably kept at 80° C. or lower, more preferably in a range of 50° C. to 80° C., further more preferably in a range of 70° C. to 80° C. during the treatment of the polyimide film.

The treating time is appropriately adjusted according to the temperature and the like of the alkaline aqueous solution used for the treatment. Elevating the temperature of the alkaline aqueous solution can increase the processing capacity that results in shortening the processing time. For example, it takes approximately 0.5 minute to 20 minutes when the solution temperature is 50° C. or higher, while it may possibly take approximately 5 minutes to 40 minutes when the solution temperature is 50° C. or lower. In either case, the surface has to be treated so that the applied adhesive firmly adhere to the surface, since the polyimide type adhesive is applied on the treated surface of polyimide film. Such a problem as reduction of adhesion by the adhesive might occur, when the processing time is excessively long. The temperature of the aqueous solution is preferably controlled by a processing equipment.

The polyimide film of the present invention may be subjected to swelling treatment prior to the surface treatment with the alkaline aqueous solution containing the permanganate. The swelling treatment can be carried out by an alkaline solution. The swelling treatment can increase the processing capacity in the surface treatment with the alkaline aqueous solution containing the permanganate.

The polyimide film of the present invention may also be subjected to reduction treatment after the surface treatment with the alkaline aqueous solution containing the permanganate. The reduction treatment can be carried out by a solution containing a reducing agent.

The reduction treatment can eliminate the permanganic acid and reaction byproducts remained on the film surface.

A surface of the polyimide film in the present invention may be treated with plasma treatment, corona discharge treatment and the like in addition to the surface treatment with the alkaline aqueous solution containing the permanganate. The plasma treatment, corona discharge treatment and the like may be carried out before, after or simultaneously the surface treatment with the alkaline aqueous solution containing the permanganate.

The polyimide film of the present invention can be used in any technical fields, and the treated surface of the film is characterized in high adhesion with a polyimide type adhesive placed on the surface. The polyimide type adhesive contains at least thermoplastic polyimide or thermoplastic polyimide precursor. Thus, it is preferable for the polyimide film of the present invention to be a part of the polyimide-metal laminate produced by forming a layer containing thermoplastic polyimide (adhesive layer), for example, by applying polyimide type adhesive on at least one surface of the polyimide film, and further forming a metal layer.

### 2. Polyimide-metal Laminate of Present Invention

The polyimide-metal laminate of the present invention includes a polyamide film of the present invention described above, a thermoplastic polyimide-containing layer (hereinafter optionally referred to as “thermoplastic polyimide layer”) placed on at least one surface of the polyimide film, and a metal layer placed on an outside of the thermoplastic polyimide layer. In the polyimide-metal laminate of the present invention, one surface or both surfaces of the polyimide film may be laminated with thermoplastic polyimide layer and the metal layer as long as the laminated surface is treated surface of the polyimide film.

The thermoplastic polyimide layer included in the polyimide-metal laminate of the present invention can serve as an adhesive layer to increase adhesion between a film and a metal layer. The polyimide-metal laminate of the present invention may have at least one layer of the thermoplastic polyimide layers, or may have two or more of the thermoplastic polyimide layers. A thickness of the thermoplastic polyimide layer (when plural thermoplastic polyimide layers are present, sum of the thickness of such layers) is adjusted according to a purpose of use of the polyimide-metal laminate sheet. The thickness of the thermoplastic polyimide layer is preferably, but not limited to, in a range of 0.5 μm to 10 μm.

The thermoplastic polyimide layer included in the polyimide-metal laminate of the present invention comprises the resin composition containing the thermoplastic polyimide. The resin composition may contain a bismaleimide (described later) in addition to the thermoplastic polyimide.

The thermoplastic polyimide can be obtained by polycondensation reaction of the raw material composition containing tetracarboxylic dianhydride component and diamine component. A mole ratio of the tetracarboxylic dianhydride component and the diamine component contained in the raw material composition (tetracarboxylic dianhydride component:diamine component) is preferably in a range of 0.90 to 1.10, more preferably in a range of 0.95 to 1.00, particularly preferably in a range of 0.97 to 1.00. The thermoplastic polyimide is preferably a polymer having an imide structure in a main chain, having a glass transition temperature in a range from 130° C. to 350° C., and having elastic modulus that decreases rapidly in the above range of the glass transition temperature. Known thermoplastic polyimides may be used.

The tetracarboxylic dianhydride component contained in the raw material composition of the thermoplastic polyimide is not particularly limited and known tetracarboxylic dianhydride components can be used. And specific examples thereof include
3,3′4,4′-benzophenonetetracarboxylic dianhydride, pyromellitic dianhydride,
3,3′,4,4′-biphenyltetracarboylic dianhydride, diphenylsulfontetracarboxylic dianhydride,
oxy-4,4′-diphthalic dianhydride,
2,2-bis[4-(3,4-dicarboxyphenoxy)phenyl]propane dianhydride, ethyleneglycolbistrimelliticdianhydride,
2,2-bis(3,4-dicarboxyphenyl)-1,1,1,3,3,3-hexafluorop ropane dianhydride,
2,2′,3,3′-benzophenonetetracarboxylic dianhydride,
1,2-bis(3,4-dicarboxybenzoyl)benzene dianhydride,
1,3-bis(3,4-dicarboxybenzoyl)benzene dianhydride,
1,4-bis(3,4-dicarboxybenzoyl)benzene dianhydride,
2,2′-bis[(3,4-dicarboxy)phenoxy]benzophenone dianhydride,
2,3′-bis[(3,4-dicarboxy)phenoxy]benzophenone dianhydride,
2,4′-bis[(3,4-dicarboxy)phenoxy]benzophenone dianhydride,
3,3′-bis[(3,4-dicarboxy)phenoxy]benzophenone dianhydride,
3,4′-bis[(3,4-dicarboxy)phenoxy]benzophenone dianhydride,
4,4′-bis[(3,4-dicarboxy)phenoxy]benzophenone dianhydride, and the like.

The examples include preferably at least one kind of tetracarboxylic dianhydrides selected from
3,3′,4,4′-benzophenonetetracarboxylic dianhydride, pyromellitic dianhydride,
3,3′,4,4′-biphenyltetracarboylic dianhydride, diphenylsulfonetetracarboxylic dianhydride.

The tetracarboxylic acid component contained in the raw material composition of the thermoplastic polyimide may be one kind of tetracarboxylic dianhydride or a combination of two kinds or more of the tetracarboxylic dianhydrides.

Specific examples of the diamine component contained in the raw material composition of the thermoplastic polyimide include
1,3-bis(3-aminophenoxy)benzene,
4,4′-bis(3-aminophenoxy)biphenyl,
1,3-bis(3-(3-aminophenoxy)phenoxy)benzene,
bis(3-(3-aminophenoxy)phenyl)ether,
bis(3-(3-(3-aminophenoxy)phenoxy)phenyl)ether,
o-phenylenediamine, p-phenylenediamine,
m-phenylenediamine, 4,4′-diaminodiphenylmethane,
3,4′-diaminodiphenylmethane,
3,3′-diaminodiphenylmethane, 4,4′-diaminodiphenyl
ether, 3,3′-diaminodiphenyl ether,
3,4′-diaminodiphenyl ether, 4,4′-diaminobenzophenone,
3,4′-diaminobenzophenone 3,3′-diaminobenzophenone,
bis(4-aminophenyl)sulfone,
bis(4-(3-aminophenoxy)phenyl)sulfone,
bis(3-aminophenyl) sulfide, bis(4-aminophenyl)sulfide,
1,3-bis(4-(4-aminophenoxy)-α,α-dimethylbenzyl)benzene,
2,2-bis(4-aminophenoxyphenyl)propane,
1,3-bis(1-(4-(4-aminophenoxy)phenyl)-1-methylethyl)benzene,
1,4-bis(1-(4-(4-aminophenoxy)phenyl)-1-methylethyl)benzene,
1,4-bis(1-(4-(3-aminophenoxy)phenyl)-1-methylethyl)benzene,
2,2-bis(3-(3-aminophenoxy)phenyl)-1,1,1,3,3,3-hexafluoropropane,
2,2-bis(3-(4-aminophenoxy)phenyl)-1,1,1,3,3,3-hexafluoropropane and the like.

Preferably at least one kind of diamine selected from 1,3-bis(3-aminophenoxy)benzene, 4,4′-bis(3-aminophenoxy)biphenyl, 4,4′-diaminodiphenyl ether, 3,3′-diaminodiphenyl ether, 3,4′-diaminodiphenyl ether and 1,3-bis(3-(3-aminophenoxy)phenoxy)benzene is used.

The diamine component contained in the raw material composition of the thermoplastic polyimide may be one kind of diamine or a combination of two or more kinds of the diamines.

Preferred combinations of the acid dianhydride component and the diamine component contained in the raw material composition of the thermoplastic polyimide are 1,3-bis(3-aminophenoxy)benzene and 3,3′,4,4′-benzophenonetetracarboxylic dianhydride or 4,4′-diaminodiphenyl ether and/or 3,4′-diaminodiphenyl ether and/or 3,3′-diaminodiphenyl ether and diphenylsulfonetetracarboxylic dianhydride. Preferably 50 mol % or more of a sum of diamine component and acid dianhydride component contained in the raw material composition are the combination of the diamines and the acid dianhydrides.

The above-described resin composition constituting the thermoplastic polyimide layer may contain bismaleimide in addition to a thermoplastic polyimide. A content of the bismaleimide contained in the resin composition may be in a range of approximately 0.1% to 50% by weight, preferably in a range of approximately 1 to 40% by weight, more preferably approximately 5 to 30% by weight.

The contained bismaleimide is preferably represented by the following general formula (5). In the general formula (5), “m” indicates an integer of 0 to 4, “—Y—” indicates —O—, —SO₂—, —S—, —CO— or a direct bond and each “Y” may be the same or different when there are plural “Y”. “R1” indicates a hydrogen atom, a halogen atom or a hydrocarbon group and each “R1” may be the same or different. Each “R1” is bonded to a different carbon, respectively.

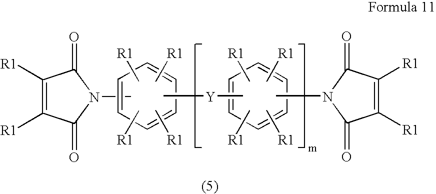

The contained bismaleimide is more preferably represented by following general formula (5′). In the general formula (5′), “m” indicates an integer of 0 to 4, “—Y—” indicates —O—, —SO₂—, —S—, —CO— or a direct bond and each “Y” may be the same or different when there are plural “Y”. “R1” indicates a hydrogen atom, a halogen atom or a hydrocarbon group and each “R1” may be the same or different. Each “R1” is bonded to a different carbon, respectively.

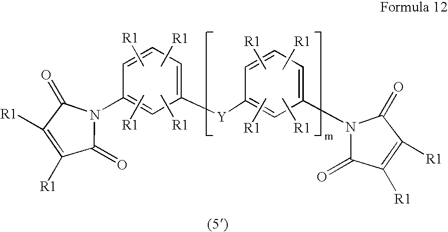

Specific examples of the contained bismaleimide include 1,3-bis(3-maleimidephenoxy)benzene, bis(3-(3-maleimidephenoxy)phenyl)ether, 1,3-bis(3-(3-maleimidephenoxy)phenoxy)benzene, bis(3-(3-(3-maleimidephenoxy)phenoxy)phenyl)ether, 1,3-bis(3-(3-(3-maleimidephenoxy)phenoxy)phenoxy)benzene, N,N′-p-phenylenebismaleimide, N,N′-m-phenylenebismaleimide, bis(4-maleimidephenyl)methane, N,N′-4,4′-diphenyl ether bismaleimide, N,N′-3,4′-diphenyl ether bismaleimide, N,N′-3,3′-diphenyl ketone bismaleimide, 2,2-bis(4-(4-maleimidephenoxy)phenyl)propane, 2,2-bis(4-(3-maleimidephenoxy)phenyl)propane, 4,4-bis(3-maleimidephenoxy)biphenyl, 2,2-bis(4-(3-maleimidephenoxy)phenyl)-1,1,1,3,3,3-he xafluorop-ropane, bis(4-(3-maleimidephenoxy)phenyl) ketone, bis(4-(3-maleimidephenoxy)phenyl)sulfide, bis(4-(3-maleimidephenoxy)phenyl)sulfone and the like, but are not particularly limited to these. The more preferable example of the contained bismaleimide is 1,3-Bis(3-maelimidephenoxy)benzene.

A metal layer contained in the polyimide-metal laminate of the present invention is placed on an outside of the thermoplastic polyimide layer. The phrase “placed on an outside of a thermoplastic polyimide layer” includes placement in direct contact with the thermoplastic polyimide layer or placement via an intermediate layer. The “intermediate layer” is, for example, a resin layer which may be an adhesion or non-adhesion layer. The metal layer is preferably placed directly on the thermoplastic polyimide layer.

The kind of metal constituting the metal layer is not particularly limited, and it includes copper, copper alloy, aluminum, nickel, stainless steel, titanium, iron and the like. The metal layer is preferably composed of a metal with a high electroconductivity, because it can be etched to be an electronic circuit. In this view, the metal layer is preferably the layer composed of copper.

A thickness of the metal layer is not limited so far as it has a thickness usable in a form of a tape, and preferably in a range of 0.1 μm to 150 μm, more preferably in a range of from 2 μm to 150 μm.

The polyimide-metal laminate of the present invention is superior in adhesion of the metal layer to the polyimide film. The meaning of “Excellent adhesion” includes, for example, a high peel strength of the metal layer. This is demonstrated in examples described later. Therefore, the polyimide-metal laminate of the present invention is suitably used as a material for a circuit board.

While a mechanism of increased adhesion of the metal layer to the polyimide film is not always clear, it is inferred that the polyimide groups on the surface of the polyimide film are in part hydrolyzed then become amide groups; and when the thermoplastic polyimide or thermoplastic polyimide precursor are cured which contained in the polyimide type adhesive applied to the polyimide film, and anchor effect caused by the amide groups formed on the surface of the polyimide film increases adhesion between the polyimide film and the thermoplastic polyimide layer and further to increase adhesion between the metal layer placed on the thermoplastic polyimide layer and the polyimide film. Thus the effect of the present invention is exerted.

### 3. Process for Producing Polyimide-Metal Laminate of Present Invention

The metal laminate of the present invention may be produced by any method and can be produced, for example, by preparing the above-described surface-treated polyimide film, applying the polyimide type adhesive to the surface-treated face of the polyimide film, drying the polyimide type adhesive applied to form a thermoplastic polyimide layer, and heat-pressing a metal foil to the formed thermoplastic polyimide layer to form a metal layer.

The metal laminate of the present invention may also be produced by providing a metal layer on only one surface of the polyimide film, while providing only any resin layer on the other surface.

On the other hand, the metal laminate of the present invention may be produced by preparing the above-described surface-treated polyimide film, preparing the polyimide film corresponding to the above-described thermoplastic polyimide layer, heat-pressing the polyimide film to the surface-treated face of the surface-treated polyimide film to form a thermoplastic polyimide layer, and heat-pressing a metal foil to the formed thermoplastic polyimide layer to form a metal layer. The metal laminate of the present invention may also be produced by heat-pressing a stack of the surface-treated polyimide film, the polyimide film corresponding to the thermoplastic polyimide film layer and the metal foil.

Further, the metal laminate of the present invention may be produced by preparing the surface-treated polyimide film and a laminate prepared by preliminarily applying at least one layer of the thermoplastic polyimide layer to a metal foil, and heat-pressing the thermoplastic polyimide layer of the prepared laminate to the surface-treated face of the polyimide film.

The metal laminate of the present invention may also be produced by forming one or two or more intermediate layers on the thermoplastic polyimide layer, and heat-pressing a metal foil to the intermediate layers to form the metal layer. The intermediate layer is, for example, a resin layer and may be formed by heat-pressing a polyimide adhesion layer or film to the formed thermoplastic polyimide layer.

Further, the metal laminate of the present invention may also be produced by preliminarily applying at least one or more of the thermoplastic polyimide layers and at least one or two or more of the above-described intermediate layers to the metal layer to form a laminate, and heat-pressing the thermoplastic polyimide layer of the formed laminate to the surface-treated face of the polyimide film.

The polyimide type adhesive to be applied to the polyimide film, the metal foil and the like preferably contains a thermoplastic polyimide or a thermoplastic polyimide precursor (for example, polyamic acid) and more preferably further contains a bismaleimide.

The polyimide type adhesive is applied to the polyimide film to form the thermoplastic polyimide layer; or is preliminarily formed in a thin film or applied to the metal foil to form a laminate, which is further heat-pressed to the polyimide film to form the thermoplastic polyimide layer. Preferably, the polyimide type adhesive is applied to the polyimide film to form the thermoplastic layer. A means to apply the polyimide type adhesive is not particularly limited and may be dissolved in a solvent and applied using a known method such as a die coater, comma coater, roll coater, gravure coater, curtain coater or spray coater and the like (a solution of the polyimide adhesive dissolved in a solvent is hereinafter optionally referred to as “varnish”). An application means may be appropriately selected according to a thickness of the thermoplastic polyimide layer to be formed, viscosity of a varnish and the like.

Concentration of the polyimide or polyimide precursor contained in the varnish is preferably 3 to 50% by weight, more preferably 5 to 30% by weight, further more preferably 10 to 20% by weight relative to a total weight of varnish as a solution.

A polyimide precursor solution obtained by the polycondensation reaction of the raw material composition containing a tetracarboxylic dianhydride component, a diamine component and a solvent, or a polyimide solution obtained by the imidization reaction of the polyimide precursor contained in the solution may be used as a varnish.

The varnish applied is dried, and cured if needed. The drying includes removal of the solvent contained in the varnish, while the curing includes imidization of the polyimide precursor (for example, polyamic acid). Drying and curing of the applied varnish can be performed using a conventional heating dry oven. An atmosphere in the dry oven is preferably filled with air, inert gas (nitrogen, argon and the like) and the like. The temperature for drying and curing may be appropriately adjusted according to a boiling point of a solvent and the like, and the temperature for drying and curing is preferably in a range of 60° C. to 600° C. Time for drying and curing may be appropriately adjusted according to a thickness of the thermoplastic polyimide layer to be formed, a solid concentration of the varnish and the kind of the solvent, and time for drying and curing is preferably in a range of approximately 0.05 minute to 500 minutes.

The polyimide-metal laminate of the present invention is preferably produced by heat-pressing a metal foil to the thermoplastic polyimide layer provided on the surface-treated face of the polyimide film; or by heat-pressing the thermoplastic polyimide layer formed on the metal foil to the surface-treated face of the polyimide film. The metal foil to be heat-pressed can be a known metal foil. Examples of the known metal foil include a rolled copper foil, an electrolytic copper foil, a copper alloy foil, an aluminum foil, a nickel foil, a stainless steel foil, a titanium foil, an iron foil and the like. The preferable example of the known metal foil is a rolled copper foil or an electrolytic copper foil.

A means to heat-press the metal foil to the thermoplastic polyimide layer is not limited, and it includes as a typical method, for example, a heat press method and/or a lamination method.

A heat press method is for example a method that the thermoplastic polyimide layer on the polyimide film and the metal foil, or the thermoplastic polyimide layer on the metal foil and the polyimide film are cut-out so as to fit the size of a press section of a press machine; stacking the cut-out parts; and heat-pressing the stack of the cut-out parts. The heating temperature is preferably in a range of 150° C. to 600° C. A pressing force is not limited. The pressing force is preferably in a range of 0.1 to 500 kg/cm². A pressing time is not particularly limited.

A heat lamination method is not particularly limited and a method to sandwich a polyimide film provided with the thermoplastic polyimide layer and a metal foil, or to sandwich a metal foil provided with the thermoplastic polyimide layer and the polyimide film between two rolls to adhere each other. The roll can be a metal roll, a rubber roll and the like. A material of the roll is not limited and steel or stainless steel can be used for the metal roll. A roll whose surface is chrome-plated or the like can be preferably used. The rubber roll preferably is a metal roll whose surface a heat resistant silicone rubber or fluoro rubber is placed on. The lamination temperature is preferably in a range of 100° C. to 300° C. The heating method includes, in addition to a conduction heating system, a radiant heating system such as far infrared irradiation and the like, an induction heating system and the like.

Performing heat annealing after heat lamination is also preferable. As a heating device, a conventional heat oven, an autoclave and the like can be used. Heat annealing can be performed under an atmosphere of air, inert gas (nitrogen or argon) and the like. As the heating method, both a method to continuously heating a film and a method to leave the film rolled around a core in a heat oven are preferred. As the heating system, a heat conduction system, a radiant heating system, a combination system thereof and the like is preferred. The heating temperature is preferably in a range of 200° C. to 600° C. The heating time is preferably in a range of 0.05 minute to 5000 minutes.

### EXAMPLE

The present invention is more specifically described with the reference of Examples and Comparative Examples below, but the scope of the present invention is not limited by these Examples. Adhesion (peel strength) between the metal layer and the polyimide film in the polyimide-metal laminate in Examples and Comparative Examples was evaluated by the method below.

### [Evaluation of Peel Strength]

A sample of a polyimide-metal laminate (length; 100 mm and width; 3.2 mm) was provided. A thermoplastic polyimide layer and a polyimide film layer of the sample were peeled from its short side edge to measure stress as prescribed in JIS C-6471. The measured value was considered as the index of the peel strength. The peel angle and the peel rate were set at 90° and 50 mm/min, respectively.

### (Synthetic Example of Thermoplastic Polyimide Precursor)

69.16 g of 1,3-bis(3-aminophenoxy)benzene and 75.85 g of 3,3′,4,4′-benzophenonetetracarboxylic dianhydride were weighed and dissolved in 822 g of N,N′-dimethylacetamide under a stream of nitrogen in a 1000 ml separable flask. After dissolution, the mixture was stirred at 60° C. for 6 hours to perform the polymerization reaction to obtain a polyamic acid solution. A content rate of the polyamic acid in the polyamic acid solution was 15% by weight. 13.24 g of 1,3-bis(3-maleimidephenoxy)benzene was added to 500 g of a part of the obtained varnish, which was stirred to dissolve at ambient temperature to form a thermoplastic polyimide precursor varnish containing the bismaleimide.

### Example 1

### Manufacture of Polyimide Film

A commercially available non-thermoplastic polyimide film (trade name Kapton™ 80EN produced by Toray Dupont Ltd., thickness; 20 μm) was subjected to swelling treatment as pretreatment with an aqueous solution of MacuDizer 9221S (450 ml/L) and MacuDizer 9276 (50 ml/L) (both produced by Nippon MacDermid Co., Ltd.) at 45° C. for 3 minutes and then washed with water.

Then, the film was immersed in an aqueous solution containing potassium permanganate (90 g/L) and sodium hydroxide (10 g/L) at 75° C. for 5 minutes as surface treatment with an alkaline aqueous solution containing a permanganate, and then further washed with water.

Then, the film was immersed in an aqueous solution of MacuDizer 9279 (100 ml/L) (produced by Nippon MacDermid Co., Ltd.) and sulfuric acid (20 ml/L) at 45° C. for 5 minutes for reduction treatment and then further washed with water.

### (Formation of Thermoplastic Polyimide Layer)

On the both surfaces of the polyimide film subjected to the each treatment, the thermoplastic polyimide precursor varnish synthesized in the Synthetic Example was applied by using a reverse roll coater, and the thermoplastic polyimide precursor varnish was dried and cured to form the thermoplastic polyimide layer. Thickness of the formed thermoplastic polyimide layer was 2 μm. Drying and curing was performed stepwisely at 100° C., 150° C., 200° C. and 250° C. for five minutes each.

### (Formation of Metal Layer)

A rolled copper foil (trade name, BHY-22B-T™ produced by Nikko Materials Co., Ltd., thickness; 18 μm) placed on the formed thermoplastic polyimide layer was sandwiched between cushion materials (trade name, Kinyo BoardTR F200 produced by KINYOSHA Co., Ltd.) and heat-pressed with a heat press machine under a condition of 300° C. and 25 kg/cm² for 4 hours. Through the process, a polyimide-metal laminate consisting of “rolled copper foil/thermoplastic polyimide/Kapton™ 80EN/thermoplastic polyimide/rolled copper foil” was produced.

### Examples 2-4

The polyimide-metal laminate was produced by a method similar to the method in Example 1 except that the composition of the alkaline aqueous solution containing a permanganate to treat the polyimide film was changed as shown in Table 1.

### Comparative Examples 1 and 2

The polyimide-metal laminate was produced by a method similar to the method in Example 1 except that the composition of the aqueous solution to treat the polyimide film was changed as shown in Table 1.

### Comparative Example 3

The polyimide-metal laminate was produced by a method similar to the method in Example 1 except that the each treatment (pretreatment, treatment with the alkaline aqueous solution containing a permanganate, and reduction treatment) was not carried out.

### (Evaluation of Polyimide-Metal Laminate)

Using the obtained polyimide-metal laminate, the peel strength was measured as described above. Their results are shown in Table 1.

TABLE 1

| Film treating | | Example | Example | Example | Example | Comparative | Comparative | Comparative |
|---|---|---|---|---|---|---|---|---|
| process | Composition | 1 | 2 | 3 | 4 | Example 1 | Example 2 | Example 3 |
| Treatment | Potassium | 90 g/L | 67 g/L | 20 g/l | 95 g/L | 100 g/L | 0 g/L | No |
| with Aqueous | permanganate | | | | | | | treatment |
| permanganate | Sodium | 10 g/L | 33 g/L | 80 g/L | 5 g/L | 0 g/L | 100 g/L | |
| solution | hydroxide | | | | | | | |

| | | | | | | | |
|---|---|---|---|---|---|---|---|
| Peel strength (kN/m) | 1.4 | 1.6 | 1.4 | 1.1 | 0.7 | 0.7 | 0.6 |

### INDUSTRIAL APPLICABILITY

The polyimide-metal laminate produced by the method of the present invention is usefully applied to a base material for a printed wiring board, a base material for an integrated suspension, a wiring base material for IC package, a heating sheet, a wiring base material for LCD and the like.

The present patent application claims the priority of the patent application No. JP2005/163466 filed on Jun. 3, 2005, the entire disclosure of which is incorporated herein by reference.

1. A polyimide film to be adhered with a polyimide type adhesive, wherein the polyimide film is surface-treated with an alkaline aqueous solution containing a permanganate.

2. The polyimide film according to claim 1, wherein the alkaline aqueous solution further comprises a hydroxide.

3. The polyimide film according to claim 2, wherein a weight ratio of the permanganate and the hydroxide contained in the alkaline aqueous solution is 9:1 to 2:8.

4. The polyimide film according to claim 2, wherein the permanganate is at least either one of potassium permanganate or sodium permanganate, and
the hydroxide is at least either one of potassium hydroxide or sodium hydroxide.

5. The polyimide film according to claim 1, wherein the polyimide film comprises the polyimide which is a polycondensate of an acid dianhydride component and a diamine component, and
50 mol % or more of the acid dianhydride component are an acid dianhydride represented by the following general formula (1), and
50 mol % or more of the diamine component are a diamine represented by the following general formula (4). 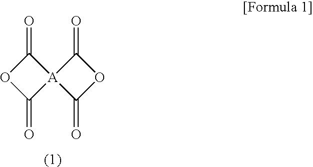
(In the formula (1), “A” indicates the following formula (2) or the following general formula (3)). 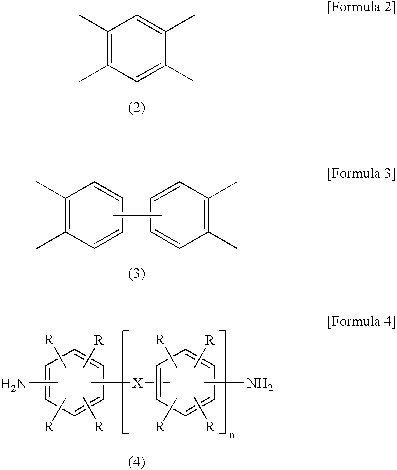
(In the formula (4),
“n” indicates an integer of 0 or 1,
“—X-” indicates —O—, —NHC(═O)— or a direct bond, and
“R” indicates a hydrogen atom, a halogen atom, a lower alkyl group or a lower alkoxy group and each “R” may be the same or different).

6. The polyimide film according to claim 1, wherein the polyimide type adhesive comprises a thermoplastic polyimide or a thermoplastic polyimide precursor, and a bismaleimide represented by the following general formula (5). 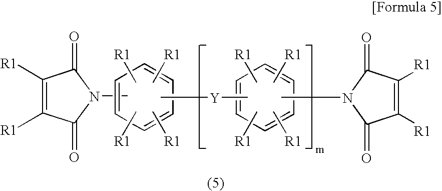
(In the formula (5),
“m” indicates an integer of 0 to 4,
“—Y—” indicates —O—, —SO₂—, —S—, —CO— or a direct bond and each “Y” may be the same or different when there is a plurality of “Y”, and
“R1” indicates a hydrogen atom, a halogen atom or a hydrocarbon group and each “R1” may be the same or different and is bonded to a different carbon, respectively.)

7. The polyimide film according to claim 6, wherein the bismaleimide is represented by the following general formula (5′). 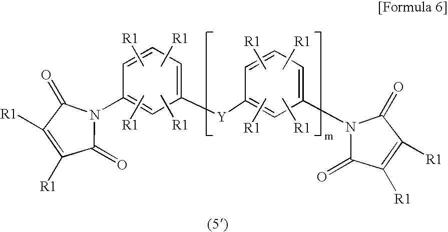
(In the formula (5′),
“m” indicates an integer of 0 to 4,
“—Y—” indicates —O—, —SO₂—, —S—, —CO— or a direct bond and each “Y” may be the same or different when there is a plurality of “Y”, and
“R1” indicates a hydrogen atom, a halogen atom or a hydrocarbon group and each “R1” may be the same or different and is bonded to a different carbon, respectively.)

8. A polyimide-metal laminate comprising:
the polyimide film according to any of claim 1 to claim 7, a thermoplastic polyimide-containing layer placed on both surfaces or one surface of the polyimide film, and
a metal layer placed on an outside of the thermoplastic polyimide-containing layer.

9. A method of producing a polyimide-metal laminate comprising:
a step of providing the polyimide film according to any of claim 1 to claim 7, a step of applying a polyimide type adhesive to one surface or both surfaces of the polyimide film to form a thermoplastic polyimide-containing layer, and
a step of forming a metal layer on an outside of the thermoplastic polyimide-containing layer.
